(19) United States
(12) Patent Application Publication
(10) Pub. No.: US 2016/0125464 A1
(43) Pub. Date: May 5, 2016

(54) TERMINAL, SERVICE PROVIDING DEVICE AND COUPON SERVER, ELECTRONIC WALLET SYSTEM COMPRISING THE SAME, CONTROL METHOD THEREOF AND NON-TRANSITORY COMPUTER READABLE STORAGE MEDIUM HAVING COMPUTER PROGRAM RECORDED THEREON

(71) Applicant: SK PLANET CO., LTD., Seongnam-si, Gyeonggi-do (KR)

(72) Inventors: Ji Eun KANG, Seoul (KR); Jong Soo LEE, Seoul (KR)

(73) Assignee: SK Planet Co., Ltd., Seongnam-si, Gyeonggi-do (KR)

(21) Appl. No.: 14/897,201

(22) PCT Filed: Nov. 24, 2014
(86) PCT No.: PCT/KR2014/011301

§ 371 Date: Dec. 9, 2015

(30) Foreign Application Priority Data
Feb. 11, 2014 (KR) 10-2014-0015367
Feb. 26, 2014 (KR) 10-2014-0022318

(51) Int. Cl. G06Q 30/02

(52) U.S. Cl. CPC G06Q 30/0257

(57) ABSTRACT

Provided are a terminal, a service providing device and a coupon server, an electronic wallet system including the same, a control method thereof, and a non-transitory computer readable storage medium having a computer program recorded thereon. That is, instead of performing an issuing procedure by assigning the coupon registered by the affiliated company one to one, coupon information (alternatively, retrieval type coupon information) related with the keyword assigned by the consumer among the coupons registered by the affiliated company is retrieved in real time and the retrieved coupon information is provided to the terminal to enhance an advertisement effect by diversifying the method of providing the coupon information, improve convenience of the user, and reduce management costs.

### CROSS-REFERENCE TO RELATED APPLICATION

This application claims the benefit of Korean Application Nos. 10-2014-0015367 filed on Feb. 11, 2014 and 10-2014-0022318 filed on Feb. 26, 2014 with the Korean Intellectual Property Office, the disclosure of which is incorporated herein by reference.

### BACKGROUND OF THE INVENTION

1. Field of the Invention

The present invention relates to a terminal, a service providing device and a coupon server, an electronic wallet system including the same, a control method thereof, and a non-transitory computer readable storage medium having a computer program recorded thereon, and more particularly, to a terminal, a service providing device and a coupon server, an electronic wallet system including the same, a control method thereof, and a non-transitory computer readable storage medium having a computer program recorded thereon capable of providing a real-time retrieval type coupon for a selected specific keyword instead of an assigned type coupon and retrieving one or more coupons related with the specific keyword corresponding to the corresponding retrieval type coupon when the retrieval type coupon is selected to provide information on one or more coupons to the terminal according to the retrieved result.

2. Description of the Related Art

An electronic wallet system is a system of managing credit cards, transportation cards, membership cards, coupons, and the like through a user terminal with a USIM card and the like and providing a payment function between the user terminal and an affiliated terminal.

Such an electronic wallet system has a structure in which when a coupon displayed on the user terminal is selected, one coupon corresponding to the selected coupon is issued to the corresponding user terminal by interlocking with a service providing device and a coupon server, and since the corresponding coupon is provided as a pre-assigned type, there is an inconvenience in retrieving a coupon related with the specific keyword and the like.

### SUMMARY OF THE INVENTION

An object of the present invention is to provide a terminal, a service providing device and a coupon server, an electronic wallet system including the same, a control method thereof, and a non-transitory computer readable storage medium having a computer program recorded thereon for retrieving in real-time information on a coupon (alternatively, information on a retrieval type coupon) related with a keyword assigned by a customer in coupons registered by an affiliated company and providing the retrieved information on the coupon to the terminal.

Another object of the present invention is to provide a terminal, a service providing device and a coupon server, an electronic wallet system including the same, a control method thereof, and a non-transitory computer readable storage medium having a computer program recorded thereon for providing information on a coupon according to real-time keyword retrieval based on the terminal instead of performing an issuance procedure by assigning a pre-assigned coupon to the terminal one to one in a coupon server.

Yet another object of the present invention is to provide a terminal, a service providing device and a coupon server, an electronic wallet system including the same, a control method thereof, and a non-transitory computer readable storage medium having a computer program recorded thereon for retrieving information on a coupon related with a specific keyword which is desired by a user of the terminal in real time in information on a plurality of coupons stored in the coupon server and providing the real-time retrieved information on the coupon related with the specific keyword to the terminal.

Still another object of the present invention is to provide a terminal, a service providing device and a coupon server, an electronic wallet system including the same, a control method thereof, and a non-transitory computer readable storage medium having a computer program recorded thereon for providing information on a present and history information related with the corresponding present.

Still yet another object of the present invention is to provide a terminal, a service providing device and a coupon server, an electronic wallet system including the same, a control method thereof, and a non-transitory computer readable storage medium having a computer program recorded thereon for storing an additionally issued coupon and information on a corresponding specific condition together when purchasing a product satisfying a predetermined condition in a specific app such as an electronic wallet app and displaying information on the specific condition together when the information on the corresponding coupon is displayed later.

According to an aspect of the present invention, a terminal includes: a communication unit configured to communicate with the outside when a preinstalled specific app is executed; a display unit configured to display a specific app execution result screen and display a coupon list received through the communication unit; and a control unit configured to control the communication unit so as to transmit information on a selected retrieval type coupon including a specific keyword when the retrieval type coupon is selected in the coupon list to a service providing device, control the display unit so as to display information on one or more coupons corresponding to the specific keyword transmitted from the service providing device in response to the transmitted information on the retrieval type coupon, control the communication unit so as to generate a coupon issuance request signal for the coupon corresponding to the selected specific coupon information and transmit the generated coupon issuance request signal to the service providing device when the specific coupon information is selected in the displayed information on one or more coupons, and register the coupon corresponding to the specific coupon information issued from the service providing device in response to the transmitted coupon issuance request signal.

Preferably, the coupon list includes assigned coupons and the retrieval type coupons, the assigned coupon is a coupon registered in an affiliated company server or a coupon server, and the retrieval type coupon is a coupon for retrieving a coupon corresponding to the keyword among a plurality of pre-registered coupons including keywords.

Preferably, information on one or more coupons is in a state in which a priority for a display sequence is set.

According to another aspect of the present invention, a coupon server includes: a storage unit configured to store a plurality of coupons; a communication unit configured to receive information on a retrieval type coupon including a specific keyword transmitted from a service providing device; and a control unit configured to retrieve a coupon corresponding to the received information on the retrieval type coupon among the plurality of stored coupons, control the communication unit so as to transmit coupon information on the retrieved coupon to the service providing device, receive a coupon issuance request signal including a request for issuing the selected specific coupon among the transmitted coupon information through the communication unit, and control the communication unit so as to issue the coupon corresponding to the received coupon issuance request signal to the service providing device.

Preferably, the control unit retrieves a coupon including the specific keyword among an affiliated company name, a coupon name, a title, and a usage place included in the stored plurality of coupon information.

Preferably, the coupon information on the retrieved coupon is information on an assigned coupon including an affiliated company name, a coupon name, a unique code, a title, a benefit, a usage place, a usage period, a usage method, and a coupon type, respectively.

According to yet another aspect of the present invention, a control method of a terminal includes: displaying a coupon list received through a communication unit on a display unit when a specific app preinstalled is executed; transmitting information on a selected retrieval type coupon including a specific keyword to the service providing device through the communication unit, when the retrieval type coupon is selected in the displayed coupon list; receiving information on one or more coupons corresponding to the specific keyword transmitted from the service providing device in response to the information on the retrieval type coupon transmitted through the communication unit; controlling the information on one or more coupons received through the control unit to be displayed on the display unit; generating a coupon issuance request signal for the coupon corresponding to the selected information on the specific coupon through the control unit, when the information on the specific coupon is selected in the displayed information on one or more coupons; transmitting the generated coupon issuance request signal to the service providing device through the communication unit; and registering a coupon corresponding to the information on the specific coupon issued from the service providing device in response to the transmitted coupon issuance request signal through the control unit.

According to still another aspect of the present invention, a control method of a coupon server includes: receiving information on a retrieval type coupon including a specific keyword transmitted from a service providing device through a communication unit; retrieving a coupon corresponding to the received information on the retrieval type coupon among a plurality of coupons pre-stored in a storage unit through the control unit; transmitting coupon information on the retrieved coupon to the service providing device through the communication unit; receiving a coupon issuance request signal including a request for issuing a specific coupon selected from the transmitted coupon information through the communication unit; and issuing a coupon corresponding to the received coupon issuance request signal to the service providing device through the control unit.

According to still yet another aspect of the present invention, a computer program executing the control methods according to the aforementioned embodiments may be stored in a non-transitory computer readable storage medium having a computer program recorded thereon.

According to still yet another aspect of the present invention, an electronic wallet system includes: a service providing device configured to provide a coupon list; a terminal configured to transmit information on a selected retrieval type coupon including a specific keyword when the retrieval type coupon is selected in the coupon list to a service providing device, generate a coupon issuance request signal for the coupon corresponding to the selected specific coupon information when information on a specific coupon is selected from information on one or more coupons corresponding the specific keyword transmitted from the service providing device in response to the transmitted information on the retrieval type coupon, transmit the generated coupon issuance request signal to the service providing device, and register a coupon corresponding to the specific coupon information issued in response to the transmitted coupon issuance request signal; and a coupon server configured to retrieving a coupon corresponding to information on the retrieval type coupon transmitted from the service providing device, providing information on one or more retrieved coupons corresponding to the specific keyword to the terminal through the service providing device, and issuing the coupon corresponding to the coupon issuance request signal transmitted from the service providing device to the terminal through the service providing device.

According to still yet another aspect of the present invention, a terminal includes: a display unit configured to display a specific app execution result screen; a communication unit communicating with the outside when a preinstalled specific app is executed; and a control unit configured to control the communication unit to receive a coupon transmitted from the service providing device, information on a condition, and purchase history information corresponding to a product when completing payment for the product satisfying a predetermined condition, and control the display unit to display the received coupon, the information on the condition, and the purchase history information corresponding to the product.

As described above, according to the present invention, it is possible to enhance an advertisement effect by retrieving coupon information (alternatively, the retrieval type coupon information) related with the keyword assigned by a consumer in real time in coupons registered by the affiliated company and providing the retrieved coupon information to the terminal to diversify a method of providing the coupon information.

Further, it is possible to provide coupon information based on a user by providing coupon information according to real-time keyword retrieval based on the terminal instead of performing an issuing procedure by assigning the pre-assigned coupon to the terminal one to one in the coupon server.

Further, it is possible to improve convenience of the user and reduce management costs by retrieving in real time coupon information related with the specific keyword which is desired by the user of the terminal among the information on a plurality of coupons stored in the coupon server and providing the coupon information related with the specific keyword retrieved in real time to the terminal.

Further, it is possible to easily verify purchase history information on a corresponding present by providing information on the present and history information related with the corresponding present together.

Further, it is possible to improve convenience of the user and enhance availability of contents by storing an additionally issued coupon and information on the corresponding specific condition together in the case of purchasing the product satisfying the predetermined condition in the predetermined app such as an electronic wallet app and displaying the information on the specific condition together when the information on the corresponding coupon is displayed later.

### BRIEF DESCRIPTION OF THE DRAWINGS

FIG. 1 is a block diagram illustrating a configuration of an electronic wallet system according to an embodiment of the present invention.

FIG. 2 is a block diagram illustrating a configuration of the electronic wallet system according to the embodiment of the present invention.

FIG. 3 is a block diagram illustrating a configuration of a terminal according to the embodiment of the present invention.

FIG. 4 is a block diagram illustrating a configuration of a service providing device according to the embodiment of the present invention.

FIG. 5 is a block diagram illustrating a configuration of a coupon server according to the embodiment of the present invention.

FIG. 6 is a block diagram illustrating a configuration of an electronic wallet system according to another embodiment of the present invention.

FIG. 7 is a signal flowchart illustrating a communicating process of an electronic wallet system according to a first embodiment of the present invention.

FIGS. 8 to 11 are diagrams illustrating a screen of a terminal according to the first embodiment of the present invention.

FIG. 12 is a signal flowchart illustrating a communicating process of an electronic wallet system according to a second embodiment of the present invention.

FIGS. 13 to 15 are diagrams illustrating a screen of a terminal according to the second embodiment of the present invention.

### DETAILED DESCRIPTION OF THE PREFERRED EMBODIMENTS

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not included or additional components or steps may be further included.

In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

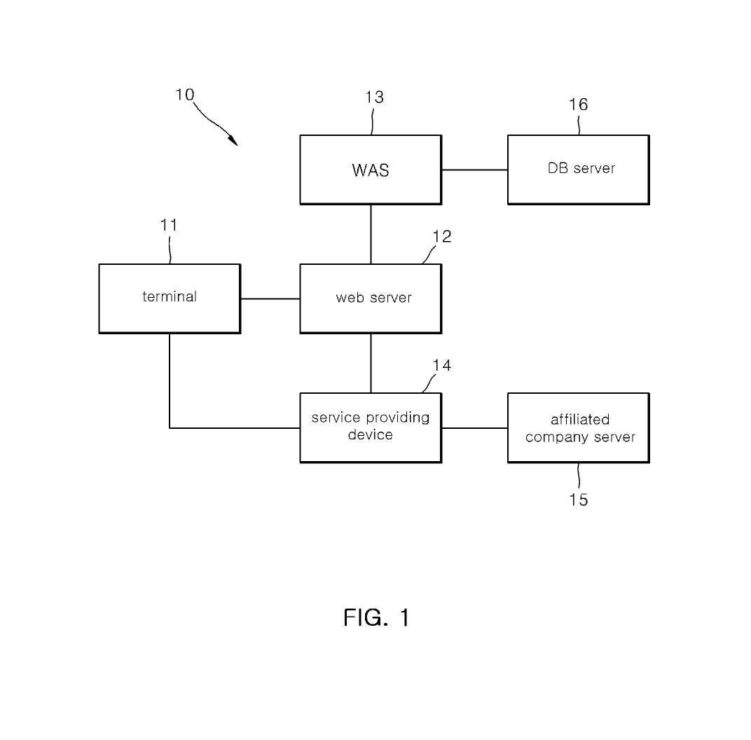

FIG. 1 is a block diagram illustrating a configuration of an electronic wallet system 10 according to an embodiment of the present invention.

As illustrated in FIG. 1, the electronic wallet system 10 is constituted by a terminal 11, a web server 12, a web application server (WAS) 13, a service providing device 14, an affiliated company server 15, and a database (DB) server 16.

All the constituent elements of the electronic wallet system 10 illustrated in FIG. 1 are not essential constituent elements, and the electronic wallet system 10 may be implemented by more constituent elements than the constituent elements illustrated in FIG. 1 or less constituent elements therethan.

The terminal 11 (alternatively, a user equipment) is identified by unique identification information such as a mobile directory number (MDN), a mobile IP, a mobile MAC, a Sim card unique information, and serial number and communicates with the web server 12 through a wired or wireless communication network. In this case, the terminal 11 receives and stores payment-related card information, coupon-related information, gift card-related information, and the like from the web server 12 and displays corresponding information when executing a specific web or selecting a specific menu. In this case, the payment-related card information may include an image or a video for the card, an affiliated company name, a card name, a card number, an expiration date, a benefit, an annual fee, barcode information/QR code information/NFC tag information/smart tag information associated with the corresponding card, and the like. Further, the coupon related information may include an affiliated company name, a coupon name, a coupon number, a benefit, a used place, a used period, a using method, and the like, and the gift card-related information may include an affiliated company name, a gift card name, a gift card number, a price, a used place, a used period, a using method, and the like.

Further, the terminal 11 receives information related with a specific payment-related card, a coupon, a ticket, a gift card, and the like selected by the user from the service providing device 14 through the web server 12. The web server 12 verifies information stored in the DB server 16 related with the corresponding to the terminal 11 through the WAS 13 based on identification information transmitted from the terminal 11 and provides the verified information to the terminal 11.

Further, when a request for issuing the payment-related card, the coupon, the ticket, the gift card, and the like is transmitted from the terminal 11, the web server 12 transmits the corresponding request to the service providing device 14 and the service providing device 14 receives related information from the affiliated company server to provide (or issue) the payment-related card, the coupon, the ticket, the gift card, and the like to the terminal 11.

As such, the web server 12 acquires and provides information stored in the DB server 16 through the WAS 13 in response to the request of the terminal 11 or provides the information transferred from the affiliated company server 15 to the terminal 11 through the service providing device 14.

The WAS 13 (alternatively, the web application server) provides the information stored in the DB server 16 to the terminal 11 through the web server 12 based on the identification information on the terminal 11 transmitted from the web server 12 and furthermore, performs distributed processing a function of the web server 12.

The service providing device 14 provides information according to the request of the terminal 11 to the terminal 11 based on the identification information on the terminal transmitted from the web server 12 or receives the corresponding information from the affiliated company server 15 and then provides the received information to the terminal 11 if necessary.

As an example, when the request for issuing the payment-related card, the coupon, the ticket, the gift card, and the like is received through the web server 12 from the terminal 11, the service providing device 14 receives the related information transmitted from the affiliated company server 15 in response to the corresponding request to transmit the received related information to the terminal 11.

That is, when the web server 12 receives the issuance request for a specific payment-related card from the terminal 11, the web server 12 transmits the corresponding issuance request to the service providing device 14 together with the identification information on the terminal. Thereafter, the service providing device 14 issues (alternatively, transmits) the corresponding payment-related card to the terminal 11 corresponding to the identification information in response to the issuance request information for the corresponding payment-related card transmitted. In this case, the service providing device 14 receives the payment-related card from the affiliated company server 15 to provide (alternatively, transmit) the received payment-related card to the terminal 11.

The affiliated company server 15 (alternatively, an affiliated company service device) is connected with the service providing device 14 with a wired or wireless communication network, and when the issuance request of the card related with the affiliated company server 15 is transferred from the service providing device 14, a payment-related card is issued to the terminal 11 through the service providing device 14 in response to the corresponding request.

The DB sever 16 is connected with the WAS 13 through the wired or wireless communication network and stores information corresponding to the identification information on the terminal 11 (including, for example, payment-related card issuance information, payment-related card usage information, issuance information on barcode/QR code/NFC tag/smart tag, usage information on barcode/QR code/NFC tag/smart tag, point reservation/ usage information, coupon issuance/usage information, and the like).

Further, the DB server 16 transmits the information on the terminal 11 corresponding to the identification information to the web server 12 through the WAS 13 in response to the request of the web server 12 including the identification information on the specific terminal 11.

Further, the electronic wallet system 10 may further include a coupon server (not illustrated) which communicates with the service providing device 14 and the affiliated company server 15.

When a coupon issuance request is received from the terminal 11, the web server 12 receives the corresponding request from the terminal 11 to transmit the received request to the service providing device 14. In addition, the service providing device 14 receives a coupon corresponding to the received request from the coupon server (alternatively, a coupon service device) to directly issue the received coupon to the terminal 11 or issue the received coupon to the terminal 11 through the web server 12. In this case, the coupon server receives (alternatively, issues) the corresponding coupon from the affiliated company server 15.

Further, the coupon server generates the corresponding coupon corresponding to the coupon issuance request (alternatively, receives the corresponding coupon from the affiliated company server 15) in response to the coupon issuance request of the web server 12 and may issue the corresponding coupon to the terminal 11 corresponding to the identification information included in the coupon issuance request.

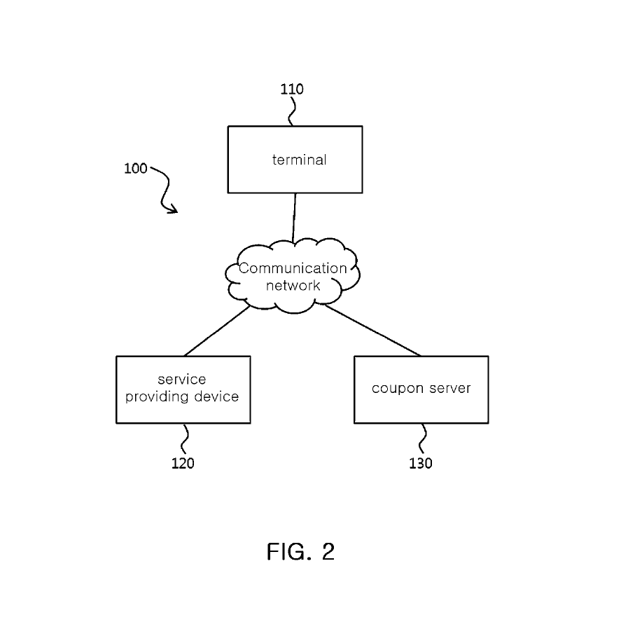

FIG. 2 is a block diagram illustrating a configuration of the electronic wallet system 100 according to the embodiment of the present invention.

As illustrated in FIG. 2, the electronic wallet system 100 is constituted by the terminal 110, the service providing device 120, and the coupon server 130. All of the constituent elements of the electronic wallet system 100 illustrated in FIG. 2 are not essential constituent elements, and the electronic wallet system 100 may be implemented by more constituent elements than the constituent elements illustrated in FIG. 2 or less constituent elements therethan.

The coupon server 130 receives information on the retrieval type coupon including the specific keyword transmitted from the terminal 110 via the service providing device 120 through the communication network and transmits one or more coupon information corresponding to information on the received retrieval type coupon to the terminal 110 through the service providing device 120 via the communication network. Thereafter, when specific coupon information is selected from information on one or more coupons displayed on the terminal 110, the terminal 110 generates a coupon issuance request signal for requesting issuance of the coupon corresponding to the selected specific coupon information and transmits the generated coupon issuance request signal to the coupon server 130 through the service providing device 120 via the communication network. Thereafter, the coupon server 130 issues the corresponding coupon corresponding to the coupon issuance request signal to the corresponding terminal 110 through the service providing device 120 via the communication network.

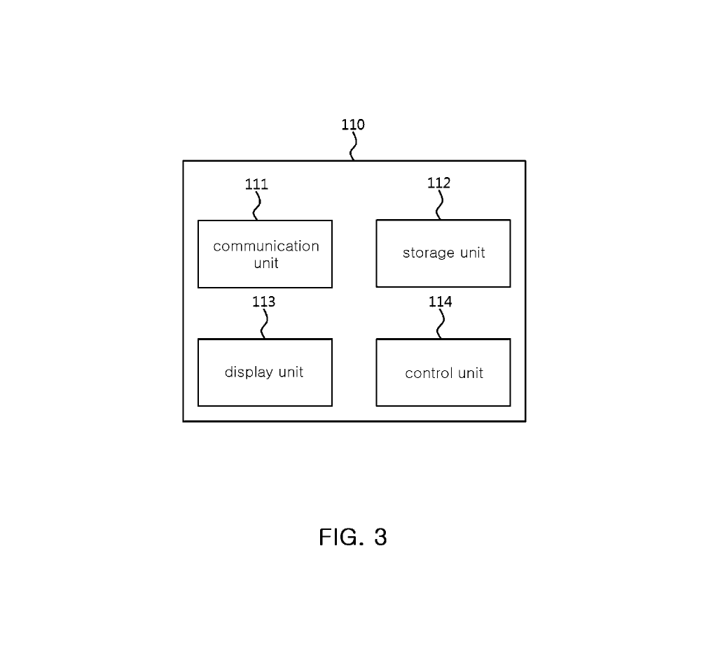

As illustrated in FIG. 3, the terminal 110 is constituted by a communication unit 111, a storage unit 112, a display unit 113, and a control unit 114. All of the constituent elements of the terminal 110 illustrated in FIG. 3 are not essential constituent elements, and the terminal 110 may be implemented by more constituent elements than the constituent elements illustrated in FIG. 3 or less constituent elements therethan.

The communication unit 111 communicates with an internal constituent element or at least one external terminal via the wired/wireless communication network. In this case, the external terminal may include the service providing device 120, the coupon server 130, and the like.

Further, the communication unit 111 receives a coupon list transmitted from the service providing device 120 or the coupon server 130 by control of the control unit 114.

The storage 112 stores a user interface (UI), a graphic user interface (GUI), and the like.

Further, the storage unit 112 stores data and programs required to operate the terminal 110.

Further, the storage unit 112 stores (alternatively, registers) a coupon issued from the service providing device 120 or the coupon server 130 by control of the control unit 114.

The display unit 113 may display contents such as a menu screen by using the UI and the GUI stored in the storage unit 112 by the control of the control unit 114. Here, the contents displayed on the display unit 113 include a menu screen including texts or image data (including various information data) and data such as icons, a list menu, and a combo box, and the like. Further, the display unit 113 may be a touch screen.

The control unit 114 executes an overall control function of the terminal 110.

Further, when a specific app such as an electronic wallet or digital wallet app pre-installed in the storage unit 112 is executed, the control unit 114 displays a specific app execution result screen corresponding to the specific app on the display unit 113. Here, the specific app execution result screen includes a my-wallet menu, an add menu, an event/news menu, a more-view menu, and the like. In this case, the more-view menu includes an activity-point menu, a housekeeping book menu, a point integrated query menu, a social network service (SNS)-related menu, and the like. In this case, the my-wallet menu is a menu storing information on the payment-related card, the coupon, the ticket, the gift card, and the like, which is installed or registered in the terminal 140 through the specific app. Further, the add menu is a menu for newly getting the payment-related card, the coupon, the ticket, other classification items through the specific app. Further, the event/news menu is a menu for verifying information on events or notices and the like transmitted from the service providing device and the like. Further, the activity-point menu is a menu for providing activity points interlocking with a plurality of predetermined apps and a plurality of apps or related companies which may use related activity points. Further, the housekeeping book menu is a menu (alternatively, a housekeeping book-dedicated app) for providing information on details of usage of the card registered in a membership item of the my-wallet menu, details of point usage, and the like in a housekeeping book form. Further, the point integrated query menu is a menu representing point information on the card registered in the membership item of the my-wallet menu. Further, the SNS-related menu is a facebook site-related menu interlocking with the specific app.

Further, when the specific app is executed, the control unit 114 identifies the terminal 110 through unique identification information such as the MDN, the mobile IP, the mobile MAC, the Sim card unique information, and a serial number of the terminal 110 and communicates with the service providing device 120 via the wired or wireless communication network. In this case, the control unit 114 transmits the identification information on the terminal 110 to the service providing device 120 in a background state, and the service providing device 120 identifies the terminal 110 based on the identification information and communicates with the terminal 110.

Further, when a predetermined specific menu (for example, a coupon menu of the add menu) is selected from the execution result screen displayed on the display unit 113, the control unit 114 receives a coupon list transmitted from the service providing device 120 through the communication unit 111.

Further, the control unit 114 displays the received coupon list on the display unit 113. Here, the coupon list includes assigned coupons and retrieval type coupons. In this case, the assigned coupon includes information on an affiliated company title (alternatively, an affiliated company name), a coupon name, an unique code (alternatively, a coupon number), a title, a benefit, a usage place, a usage period, a usage method, a coupon type (for example, a free coupon or a paid coupon), and the like and may be a coupon registered by the affiliated company server (not illustrated) or the coupon server 130. Further, the retrieval type coupon includes a specific keyword (including, for example, a keyword corresponding to the affiliated company title, a keyword corresponding to the usage place, a keyword corresponding to a product name/goods name, or the like), and is not a real coupon actually registered by the affiliated company server or the coupon server 130 and used for retrieving the coupon actually registered in the coupon server 130 through the corresponding keyword. Further, the retrieval type coupon may be generated in the terminal 110 and then registered in the service providing device 120 or the coupon server 130 or automatically generated in the service providing device 120 or the coupon server 130 in response to the specific keyword and then registered in the service providing device 120 or the coupon server 130.

When the coupon list is displayed on the display unit 113, the control unit 114 may also display the coupon list by varying a character color, a character size, a character font, a background color, and the like of the assigned coupon and the retrieval type coupon so that the user easily determines the assigned coupon or the retrieval type coupon.

Further, when the assigned coupon is selected from the coupon list displayed on the display unit 113, the control unit 114 gets the corresponding assigned coupon to the terminal 110 by interlocking with the service providing device 120 and the coupon server 130 with respect to the selected assigned coupon.

Further, when the retrieval type coupon is selected from the coupon list displayed on the display unit 113, the control unit 114 transmits information on the selected retrieval type coupon to the service providing device 120 through the communication unit 118. Here, the information on the selected retrieval type coupon includes a specific keyword included in the selected corresponding retrieval type coupon.

Further, the control unit 114 receives the retrieved coupon information transmitted from the service providing device 120 through the communication unit 111 in response to the transmitted information on the retrieval type coupon. Here, the retrieved coupon information may be information on the assigned coupon and information on one or more coupons retrieved in real time in the coupon server 130 in response to the information on the retrieval type coupon. Further, the retrieved coupon information may be in a state where a priority for a display sequence displayed on the terminal 110 is set.

Further, the control unit 114 displays the retrieved coupon information on the display unit 113.

Further, when any one coupon information is selected from the retrieved coupon information displayed on the display unit 113, the control unit 114 generates a coupon issuance request signal for the coupon corresponding to the selected coupon information. Here, the coupon issuance request signal includes information on an affiliated company name, a coupon type, a coupon name, a benefit, a usage place, a usage period, a usage method, and the like, identification information on the terminal 110, and the like. In this case, the identification information on the terminal 110 includes an MDN of the terminal 110, a mobile IP, a mobile MAC, Sim card unique information, a serial number, and the like.

Further, the control unit 114 transmits the generated coupon issuance request signal to the service providing device 120 through the communication unit 111 to request the corresponding coupon issuance.

Further, the control unit 114 receives the corresponding coupon issued from the service providing device 120 through the communication unit 111 in response to the transmitted coupon issuance request signal.

Further, the control unit 114 registers (alternatively, stores) the corresponding received coupon in the storage unit 112.

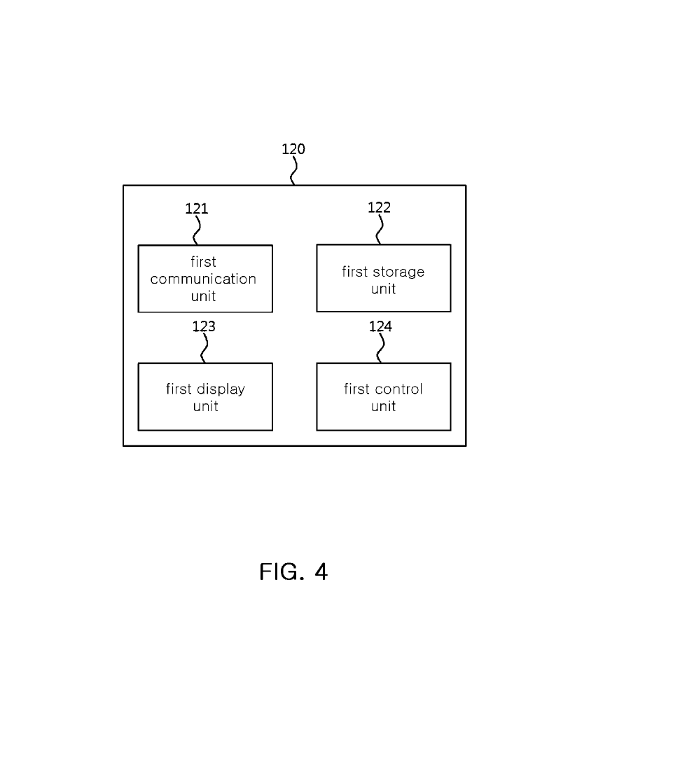

As illustrated in FIG. 4, the service providing device 120 is constituted by a first communication unit 121, a first storage unit 122, a first display unit 123, and a first control unit 124. All of the constituent elements of the service providing device 120 illustrated in FIG. 4 are not essential constituent elements, and the service providing device 120 may be implemented by more constituent elements than the constituent elements illustrated in FIG. 4 or less constituent elements therethan.

The first communication unit 121 communicates with an internal constituent element or at least one external terminal via the wired/ wireless communication network. In this case, the external terminal may include the terminal 110, the coupon server 130, and the like.

Further, the first communication unit 121 receives coupon information including a keyword (alternatively, keyword information or information on the keyword) transmitted from the terminal 110.

Further, the first communication unit 121 receives the coupon issuance request signal transmitted from the terminal 110. Here, the coupon issuance request signal includes information on an affiliated company name, a coupon type, a coupon name, a benefit, a usage place, a usage period, a usage method, and the like, identification information on the terminal 110, and the like. In this case, the identification information on the terminal 110 includes an MDN of the terminal 110, a mobile IP, a mobile MAC, Sim card unique information, a serial number, and the like.

Further, the first communication unit 121 receives a specific coupon issued (alternatively, transmitted) from the coupon server 130.

The first storage unit 122 stores a user interface (UI), a graphic user interface (GUI), and the like.

Further, the first storage unit 122 stores data, programs, and the like required to operate the service providing device 120.

Further, the first storage unit 122 stores a coupon issued from the coupon server 130 by a control of the first control unit 124.

The first display unit 123 may display contents such as a menu screen by using the UI and the GUI stored in the first storage unit 122 by the control of the first control unit 124. Here, the contents displayed on the first display unit 123 include a menu screen including texts or image data (including various information data) and data such as icons, a list menu, and a combo box, and the like. Further, the first display unit 123 may be a touch screen.

The first control unit 124 executes an overall control function of the service providing device 120.

Further, the first control unit 124 transmits coupon information including the received keyword to the coupon server 130 through the first communication unit 121.

Further, the first control unit 124 receives coupon information (alternatively, coupon information on the retrieved coupon) corresponding to the keyword transmitted from the coupon server 130 in response to the coupon information including the transmitted keyword through the first communication unit 121 and transmits the coupon information corresponding to the received keyword to the terminal 110 through the first communication unit 121.

Further, the first control unit 124 receives the coupon issuance request signal transmitted from the terminal 110 through the first communication unit 121 and transmits the received coupon issuance request signal to the corresponding coupon server 130 corresponding to the information included in the coupon issuance request signal through the first communication unit 121 to request the issuance of the coupon corresponding to the corresponding coupon issuance request signal.

Further, the first control unit 124 receives the coupon issued (alternatively, transmitted) from the coupon server 130 in response to the transmitted coupon issuance request signal through the first communication unit 121 and issues (alternatively, transmits) the received coupon to the terminal 110 through the first communication unit 121. In this case, the first control unit 124 counts the number of coupons for each coupon type issued in the terminal 110.

Further, the first control unit 124 matches the coupon number included in the received coupon with unique information on the corresponding coupon and the identification information on the terminal 110 and stores the matched information (for example, the matched coupon number, the unique information on the coupon, and the identification information on the terminal 110) in the first storage unit 122.

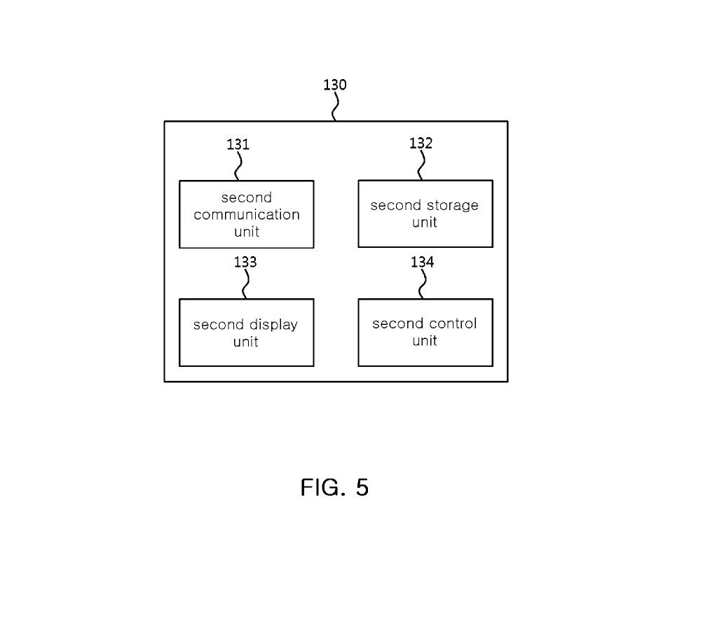

As illustrated in FIG. 5, the coupon server 130 is constituted by a second communication unit 131, a second storage unit 132, a second display unit 133, and a second control unit 134. All the constituent elements of the coupon server 130 illustrated in FIG. 5 are not essential constituent elements, and the coupon server 130 may be implemented by more constituent elements than the constituent elements illustrated in FIG. 5 or less constituent elements therethan.

The second communication unit 131 communicates with an internal constituent element or at least one external terminal via the wired/wireless communication network. In this case, the external terminal may include the terminal 110, the service providing device 120, and the like.

Further, the second communication unit 131 receives information on the retrieval type coupon transmitted from the service providing device 120. Here, the information on the retrieval type coupon includes a specific keyword included in the selected corresponding retrieval type coupon.

Further, the second communication unit 131 receives a coupon issuance request signal transmitted from the service providing device 120.

The second storage unit 132 stores a user interface (UI), a graphic user interface (GUI), and the like.

Further, the second storage unit 132 stores data, programs, and the like required to operate the coupon server 130.

Further, the second storage unit 132 stores a coupon issued from the terminal 110 or the service providing device 120 by a control of the second control unit 134.

The second display unit 133 may display contents such as a menu screen by using the UI and the GUI stored in the second storage unit 132 by the control of the second control unit 134. Here, the contents displayed on the second display unit 133 include a menu screen including texts or image data (including various information data) and data such as icons, a list menu, and a combo box, and the like. Further, the second display unit 133 may be a touch screen.

The second control unit 134 executes an overall control function of the coupon server 130.

Further, the second control unit 134 retrieves a coupon corresponding to the information on the received retrieval type coupon among the plurality of coupons which is pre-stored in the second storage unit 132.

That is, the second control unit 134 retrieves the coupon including the specific keyword received among the affiliated company title (alternatively, the affiliated company name, the coupon name, the title, and the usage place corresponding to each of the plurality of pre-stored coupons.

As the retrieved result, in the case where the coupon including the received specific keyword among the plurality of pre-stored coupons exists, the second control unit 134 transmits the coupon information (alternatively, the coupon) on the retrieved coupon to the service providing device 120 through the second communication unit 131. Here, in the retrieved coupon information, a priority displayed on the terminal 110 may be set by the control of the coupon server 130 or the service providing device 120. Further, the retrieved coupon is an assigned coupon.

Further, as the retrieved result, in the case where the coupon including the received specific keyword among the plurality of pre-stored coupons does not exist, the second control unit 134 transmits information representing that the coupon corresponding to the corresponding keyword does not exist to the service providing device 120 through the second communication unit 131. Thereafter, the service providing device 120 transmits the information representing that the coupon corresponding to the corresponding keyword does not exist to the terminal 110. Thereafter, the terminal 110 receives the information representing that the coupon corresponding to the corresponding keyword transmitted from the service providing device 120 does not exist and displays the received information.

Further, the second control unit 134 verifies the coupon corresponding to the received coupon issuance request signal among the plurality of coupons which is pre-stored in the second storage unit 132.

Further, the second control unit 134 issues (alternatively, transmits) the verified corresponding coupon to the service providing device 120 through the second communication unit 131.

Further, the second control unit 134 matches the identification information on the terminal 110 included in the coupon issuance request signal received through the second communication unit 131 with the coupon number corresponding to the verified coupon and stores the matched coupon number corresponding to the corresponding coupon and identification information on the terminal 110 in the second storage unit 132.

In the embodiment of the present invention, executing the function of retrieving the coupon corresponding to the information on the retrieval type coupon and the function of issuing the corresponding coupon corresponding to the coupon issuance request signal in the coupon server 120 are exemplified, but the present invention is not limited thereto. In addition, the function of retrieving the coupon corresponding to the information on the retrieval type coupon and the function of issuing the corresponding coupon corresponding to the coupon issuance request signal may be executed in the service providing device 120.

As such, in the coupon registered by the affiliated company, coupon information (alternatively, the retrieval type coupon information) related with the keyword assigned by a consumer is retrieved in real time and the retrieved coupon information may be provided to the terminal.

Further, as such, in the coupon server, instead of performing an issuing procedure by assigning the pre-assigned coupon to the terminal one to one, the coupon information according to real-time keyword retrieval based on the terminal may be provided.

Further, as such, among the information on a plurality of coupons stored in the coupon server, coupon information related with the specific keyword which is desired by the user of the terminal is retrieved in real time and the coupon information related with the specific keyword retrieved in real time may be provided to the terminal.

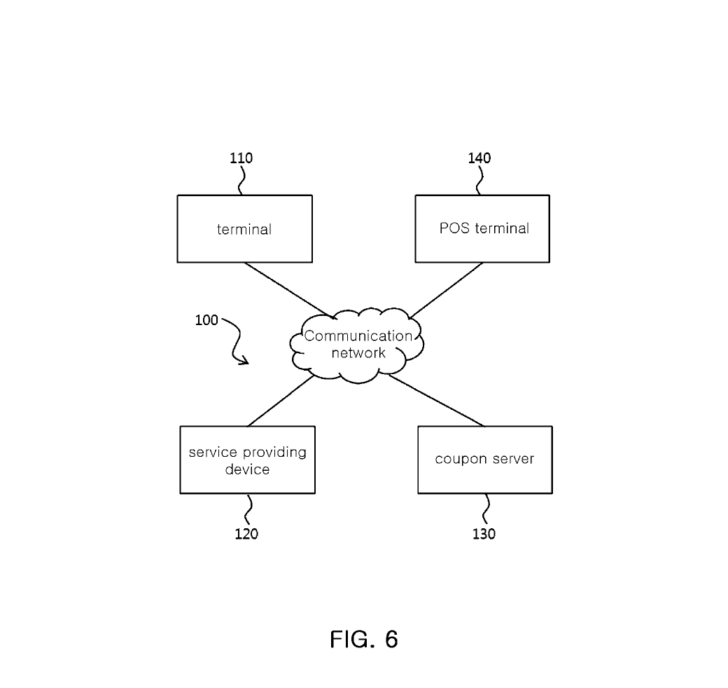

FIG. 6 is a block diagram illustrating a configuration of an electronic wallet system 100 according to another embodiment of the present invention.

As illustrated in FIG. 6, the electronic wallet system 100 is constituted by a terminal 110, a point of sale (POS) terminal 140, a service providing device 120, and a coupon server 130. All of the constituent elements of the electronic wallet system 100 illustrated in FIG. 6 are not essential constituent elements, and the electronic wallet system 100 may be implemented by more constituent elements than the constituent elements illustrated in FIG. 6 or less constituent elements therethan.

When purchasing a product satisfying a predetermined condition, the terminal 110 registers purchase history information on the corresponding product and the corresponding condition in addition to the coupon corresponding to the condition provided via the communication network in a predetermined specific app such as an electronic wallet app. Thereafter, when the specific app is executed and the coupon information on the corresponding coupon is displayed, the registered purchase history information on the corresponding product and corresponding condition in addition to the coupon information through the specific app.

The communication unit 111 communicates with an internal constituent element or at least one external terminal via the wired/wireless communication network. In this case, the external terminal may include the POS terminal 140, the service providing device 120, the coupon server 130, and the like.

Further, the communication unit 111 receives an additionally issued (alternatively, presented) coupon, information on a condition for getting a predetermined corresponding coupon, purchase history information corresponding to a product for getting the corresponding coupon, and the like, from the service providing device 120 or the coupon server 130 by the control of the control unit 114.

The storage unit 112 stores (alternatively, registers) the additionally issued (alternatively, presented) coupon, the information on the condition for getting a predetermined corresponding coupon, the purchase history information corresponding to the product for getting the corresponding coupon, and the like, from the service providing device 120 or the coupon server 130 by the control of the control unit 114.

Further, the storage unit 112 stores a payment- related card, a coupon, a gift card, and the like which are issued from the service providing device 120 or the coupon server 130 by the control of the control unit 114. Here, the payment-related card includes a credit card, a check card, a point card, and the like in addition to a membership card.

When a product satisfying a predetermined condition is purchased through the payment-related card (alternatively, the coupon/ the gift card, and the like) registered in the terminal 110, the control unit 114 receives the additionally issued (alternatively, presented) coupon, the information on the corresponding condition, the purchase history information corresponding to the product, and the like from the service providing device 120 and the coupon server 130 through the communication unit 111 in response to the predetermined condition. Here, the coupon includes coupon information on an affiliated company title (alternatively, an affiliated company name) issuing a coupon, a coupon name, a unique code (alternatively, a coupon number), a title, a benefit, a usage place, a usage period (alternatively, an expiration date, a usage method, a coupon type (for example, a free coupon or a paid coupon), and the like. Further, information on a predetermined condition may be information on a purchasing condition of the corresponding product for issuing the corresponding coupon. Further, the purchase history information on the corresponding product includes information on one or more purchase dates purchasing the corresponding product, a purchase price, and the like.

Further, the control unit 114 registers (alternatively, stores) the received coupon, information on the corresponding condition, the purchase history information corresponding to the product, and the like in a specific app.

Further, the control unit 114 displays the received coupon, the information on the corresponding condition, the purchase history information corresponding to the product, and the like on the display unit 113 through the specific app.

That is, when purchasing the product satisfying the predetermined condition, the control unit 114 displays one or more payment-related cards (alternatively, coupons/gift cards) registered in the storage unit 112 on the display unit 113 through the specific app. Further, when a specific payment-related card is selected from one or more payment-related cards displayed on the display unit 113, the control unit 114 verifies the selected payment-related card. Here, the payment-related card includes a credit card, a check card, a point card, and the like in addition to a membership card. Further, the control unit 114 performs a payment function for the corresponding product through the selected payment-related card (alternatively, the coupon/the gift card, or the like) by interlocking with the POS terminal 140 provided in a store. Further, after the payment function is performed through the POS terminal 140 based on the transmitted information on the payment-related card, a certification number, and the like, the control unit 114 receives a push message including payment information (for example, including a payment price and the like) of the corresponding paid payment-related card transmitted through the service providing device 120 in the POS terminal 140 through the communication unit 111. Further, the control unit 114 displays the received payment information on the display unit 113 through the specific app. Further, after the payment function is performed through the POS terminal 140 based on the transmitted information on the payment-related card, the certification number, and the like, the control unit 114 receives a coupon additionally issued (alternatively, presented) from the service providing device 120 and the coupon server 130, information on the corresponding condition, purchase history information corresponding to the corresponding product, and the like through the communication unit 111. Further, the control unit 114 registers (alternatively, stores) the received coupon, the information on the corresponding condition, the purchase history information corresponding to the product, and the like in a specific app. Further, the control unit 114 displays the received coupon, the information on the corresponding condition, the purchase history information corresponding to the product, and the like on the display unit 113 through the specific app.

Further, when the specific app installed in the terminal 110 is re-executed or the corresponding coupon registered in the specific app is selected, the control unit 114 displays an execution result screen on the display unit 113 and communicates with the service providing device 120 via the communication network in a background state.

Further, when a predetermined menu (for example, a my-wallet menu) is selected (alternatively, touched) in the execution result screen displayed on the display unit 113, the control unit 114 displays a first screen corresponding to the selected predetermined menu on the display unit 113 of the terminal 110. In this case, the first screen displayed on the display unit 113 includes a membership menu, a coupon/ticket menu, a payment menu, and the like which correspond to submenus of the predetermined menu (alternatively, a category).

Further, when the coupon/ticket menu is selected in the first screen displayed on the display unit 113, the control unit 114 displays coupon/ticket information corresponding to one or more coupons or tickets which are pre-registered (alternatively, issued/installed) in the terminal 110 (alternatively, the specific app) on the display unit 113. Here, the coupon/ticket information includes information on an affiliated company title (alternatively, an affiliated company name), a coupon/ticket type, a coupon/ ticket name, a coupon/ticket number (alternatively, a unique code), a title, a benefit, a usage place, a usage period (alternatively, an expiration date), a usage method, and the like. In this case, when the coupon issued when purchasing the product corresponding to the predetermined condition exists in the coupons displayed on the display unit 113, the control unit 114 displays condition information for getting the corresponding coupon, purchase history information on the product for getting the corresponding coupon, and the like in addition to the coupon information on the corresponding coupon, on the display unit 113.

Further, when the coupon information on the coupon issued when purchasing the product corresponding to the predetermined condition is selected in the coupon/ticket information corresponding to one or more coupons or tickets displayed on the display unit 113, the control unit 114 performs a payment function through the corresponding coupon information without a separate verification procedure for satisfying the condition by interlocking with the POS terminal 140 and the service providing device 120. That is, when the coupon information on the coupon issued when purchasing the product corresponding to the predetermined condition, the condition information for getting the corresponding coupon, and the coupon information corresponding to the purchase history information on the product for getting the corresponding coupon are selected in the coupon/ticket information corresponding to one or more coupons or tickets displayed on the display unit 113, the control unit 114 performs the payment function through the corresponding coupon information by interlocking with the POS terminal 140 and the service providing device 120. Further, the control unit 114 uses (alternatively, deletes) the coupon corresponding to the coupon information.

Further, after the payment function is normally completed, the control unit 114 receives a push massage through the communication unit 111 including payment information (for example, including a payment price and the like) of the coupon corresponding to the paid coupon information transmitted through the service providing device 120 in the POS terminal 140. Further, the control unit 114 displays the received payment information on the display unit 113 through the specific app.

The POS terminal 140 communicates with an internal constituent element or at least one external terminal via the wired/wireless communication network. In this case, the external terminal may include the terminal 110, the service providing device 120, the coupon server 130, and the like.

Further, the POS terminal 140 communicates with the terminal 110 to purchase a specific product and performs a payment function for the payment price corresponding to the product based on the information on the payment-related card (alternatively, the coupon/ gift card) transmitted from the corresponding terminal 110.

Further, after the payment function for the corresponding product is performed, the POS terminal 140 transmits information on the corresponding product, information on the predetermined condition corresponding to the product (alternatively, condition information), payment information, store information on a store where the POS terminal 130 is positioned, identification information on the corresponding terminal 110, and the like, to the service providing device 120. Here, the store information on the store where the POS terminal 130 is positioned may be replaced with any one of identification information on the POS terminal 130, unique information on the POS terminal 130, and unique identification information on the store where the POS terminal 130 is positioned.

In the embodiment of the present invention, the payment function is performed through the payment-related card which is pre-registered in the terminal 110, but is not limited thereto, and the payment function may be performed even through the coupon or the gift card which is pre-registered in the terminal 110.

Further, in the case of using the coupon issued when purchasing the product satisfying the predetermined condition in the terminal 110, the POS terminal 140 performs the payment function through the corresponding coupon. Thereafter, the POS terminal 140 transmits the coupon information on the paid coupon (for example, including a paid price and the like), the store information on the store where the POS terminal 140 is positioned (alternatively, the identification information on the POS terminal 140, the unique information on the POS terminal 140, or the unique identification information on the store where the POS terminal 140 is positioned), and the identification information on the terminal 110, to the service providing device 120.

The first communication unit 121 communicates with an internal constituent element or at least one external terminal via the wired/wireless communication network. In this case, the external terminal may include the terminal 110, the POS terminal 140, the coupon server 130, and the like.

Further, the first communication unit 121 receives the identification information on the terminal 110 transmitted from the terminal 110 by the control of the first control unit 124.

Further, the first communication unit 121 receives the payment information, the information on the corresponding product, the information (alternatively, the condition information) on the predetermined condition corresponding to the product, the store information on the store where the POS terminal 140 is positioned, the identification information on the corresponding terminal 110, and the like, which are transmitted from the POS terminal 140 by the control of the first control unit 124.

The first storage unit 122 stores the payment information, the information on the corresponding product, the information (alternatively, the condition information) on the predetermined condition corresponding to the product, the store information on the store where the POS terminal 140 is positioned, the identification information on the corresponding terminal 110, and the like, which are transmitted from the POS terminal 140 received from the first communication unit 121 by the control of the first control unit 124.

The first control unit 124 transmits the received payment information to the corresponding terminal 110 corresponding to the identification information on the terminal 110 through the first communication unit 121 in a push message form.

In the embodiment of the present invention, the payment function is performed based on the information on the payment-related card transmitted from the terminal 110 in the POS terminal 140, but is not limited thereto, and the corresponding payment function may also be performed in the service providing device 120.

That is, the POS terminal 140 receives the information on the payment-related card, information on one or more products, the identification information on the terminal 110, and the like, which are transmitted from the terminal 110. Thereafter, the POS terminal 140 transmits the store information on the store where the POS terminal 140 is positioned in addition to the received information on the payment-related card, the information on one or more products, and the identification information on the terminal 110, and the like, to the service providing device 120. Thereafter, the first control unit 124 performs a payment function for the paid price corresponding to the information on one or more products through the payment-related card corresponding to the received information on the payment-related card. Thereafter, the first control unit 124 transmits the payment information (for example, including the paid price and the like) of the paid payment-related card to the POS terminal 140 and the corresponding terminal 110 corresponding to the identification information on the terminal 110 through the first communication unit 121, respectively.

Further, the first control unit 124 judges (alternatively, determines) whether to issue the coupon based on the received information on the product and the received information on the condition in the pre-stored purchase history information on the plurality of products of the corresponding terminal 110. Here, the information on the predetermined condition may be information on the purchasing condition of the corresponding product for issuing the corresponding coupon. Further, the purchasing history information on the corresponding product includes information on one or more purchase dates purchasing the corresponding product, a purchase price, and the like.

That is, the first control unit 124 reflects the received information on the product in the purchase history information on the plurality of products purchased by the corresponding terminal 110 to the purchase history information correspondingly to the terminal 110 and verifies whether the reflected purchase history information on the corresponding product (alternatively, the purchase history information on the corresponding product in which the received information on the product (alternatively, the purchase information on the product) is reflected to the pre-stored purchase history information) satisfies the predetermined condition to determine whether to issue the coupon.

As the determined result, when additional coupon issuance is not required, that is, the purchase history information on the corresponding product in which the received information on the product is reflected to the pre-stored purchase history information does not satisfy the predetermined condition, the first control unit 124 stores the reflected purchase history information on the corresponding product in the first storage unit 122.

Further, as the determined result, when the additional coupon issuance is required, that is, the purchase history information on the corresponding product in which the received information on the product is reflected to the pre-stored purchase history information satisfies the predetermined condition, the first control unit 124 generates the coupon issuance request signal in order to request issuance of the predetermined coupon in response to the corresponding condition.

Further, the first control unit 124 transmits the generated coupon issuance request signal, that is, the identification information on the terminal 110 and the like to the coupon server 130 through the first communication unit 121 to request the coupon issuance.

Further, the first control unit 124 receives the coupon issued from the coupon server 130 through the first communication unit 121 in response to the coupon issuance request (alternatively, in response to the transmitted coupon issuance request signal). Here, the coupon includes coupon information on an affiliated company title (alternatively, an affiliated company name) issuing a coupon, a coupon name, a unique code (alternatively, a coupon number), a title, a benefit, a usage place, a usage period (alternatively, an expiration date), a usage method, a coupon type (for example, a free coupon or a paid coupon), and the like.

Further, the first control unit 124 issues (alternatively, transmits) the coupon issued from the coupon server 130 to the corresponding terminal 110 corresponding to the identification information on the terminal 110 through the first communication unit 121. In this case, the first control unit 124 transmits the pre-stored purchase history information on the corresponding product and the information on the predetermined condition for issuing the corresponding coupon to the corresponding terminal 110 together as well as the coupon.

Further, in the case of satisfying the predetermined condition, when the issued coupon is used in the corresponding terminal 110, the first control unit 124 performs the payment function through the corresponding coupon by interlocking with the terminal 110 and the POS terminal 140 and provides the payment function performed result to the terminal 110.

The coupon server 130 communicates with the terminal 110, the POS terminal 140, the service providing device 120, and the like.

Further, the coupon server 130 generates the coupon and performs a function of issuing the generated coupon to the terminal 110.

Further, in the case of purchasing the product satisfying the predetermined condition in the terminal 110, the coupon server 130 receives the coupon issuance request signal transmitted from the service providing device 120.

Further, the coupon server 130 generates the coupon corresponding to the corresponding condition in response to the received coupon issuance request signal and issues the generated coupon corresponding to the corresponding condition to the corresponding terminal 110 through the service providing device 120. Here, the coupon includes coupon information on an affiliated company title (alternatively, an affiliated company name) issuing a coupon, a coupon name, a unique code (alternatively, a coupon number), a title, a benefit, a usage place, a usage period (alternatively, an expiration date), a usage method, a coupon type (for example, a free coupon or a paid coupon), and the like.

Further, the coupon server 130 matches the identification information on the terminal 110 getting the coupon with the coupon information on the issued coupon and stores the matched information.

Further, the coupon server 130 counts the number of issued coupons.

As such, the coupon server 130 may provide not only information on a present but also history information related with the corresponding present together.

Further, as such, in the case of purchasing the product satisfying the predetermined condition in the predetermined app such as an electronic wallet app, an additionally issued coupon and information on the corresponding specific condition are stored together, and the information on the specific condition may be displayed together when the information on the corresponding coupon is displayed later.

Hereinafter, a control method of the electronic wallet system according to the present invention will be described in detail with reference to FIGS. 1 to 15.

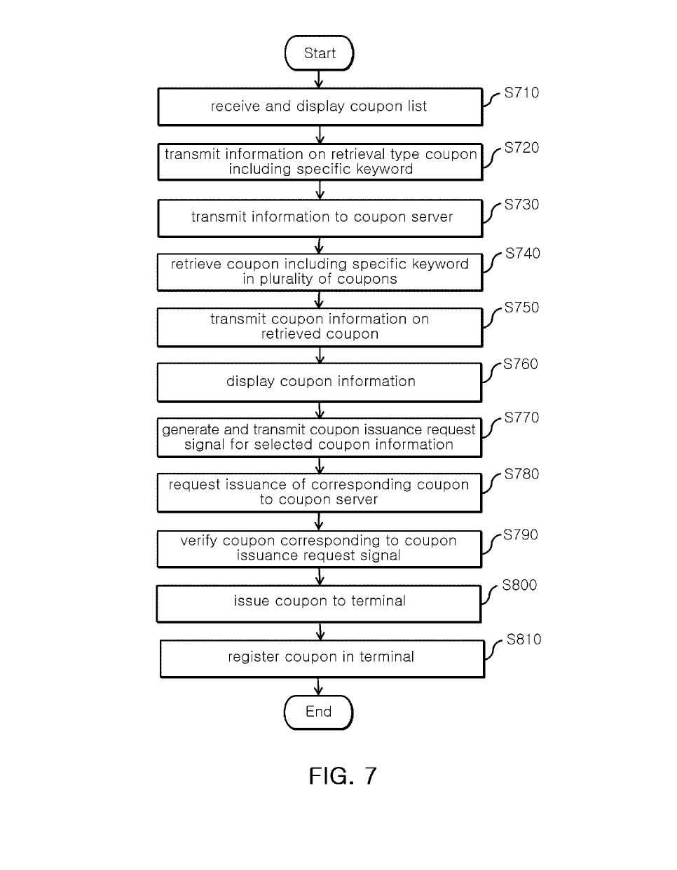

FIG. 7 is a signal flowchart illustrating a communicating process of an electronic wallet system according to a first embodiment of the present invention.

First, when the specific app such as the electronic wallet app installed in the terminal 110 is executed, the terminal 110 displays the execution result screen on the display unit 113 and may communicate with the service providing device 120 via the wired or wireless communication network in a background state.

Further, when a predetermined specific menu (for example, a coupon menu of the add menu) is selected from the execution result screen displayed on the terminal 110, the terminal 110 displays a coupon list transmitted from the service providing device 120 on the display unit 113. Here, the coupon list includes assigned coupons and retrieval type coupons. In this case, the assigned coupon includes information on an affiliated company title (alternatively, an affiliated company name), a coupon name, an unique code (alternatively, a coupon number), a title, a benefit, a usage place, a usage period, a usage method, a coupon type (for example, a free coupon or a paid coupon), and the like and may be a coupon registered in the service providing device 120 or the coupon server 130 by an affiliated company server (not illustrated) or the coupon server 130. Further, the retrieval type coupon includes a specific keyword (for example, including a keyword corresponding to the affiliated company title, a keyword corresponding to the usage place, a keyword corresponding to a product name/goods name, or the like), and is not a real coupon actually registered by the affiliated company server or the coupon server 130 and used for retrieving the coupon corresponding to the corresponding keyword among the pre-registered plurality of coupons.

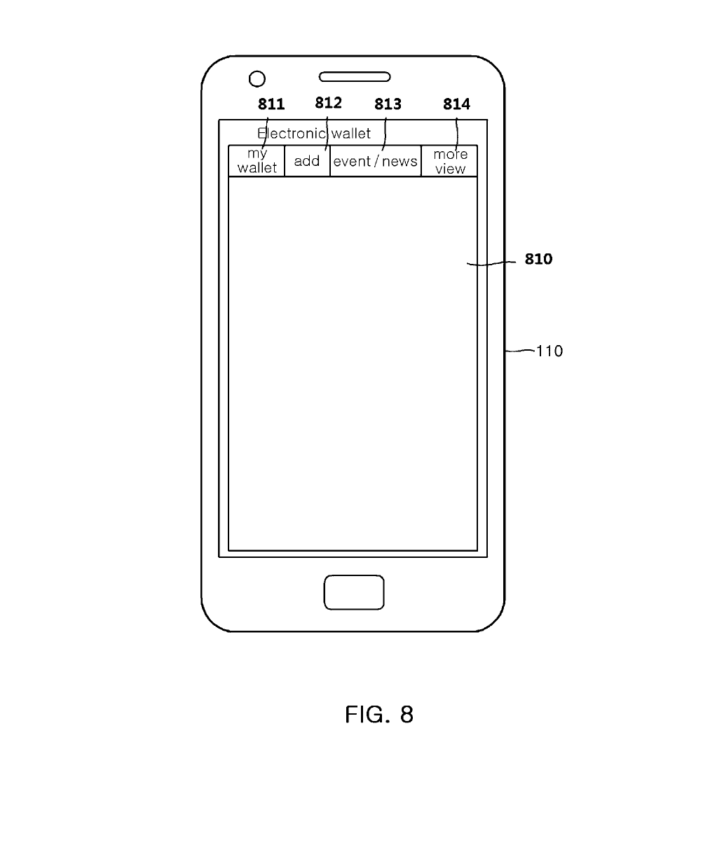

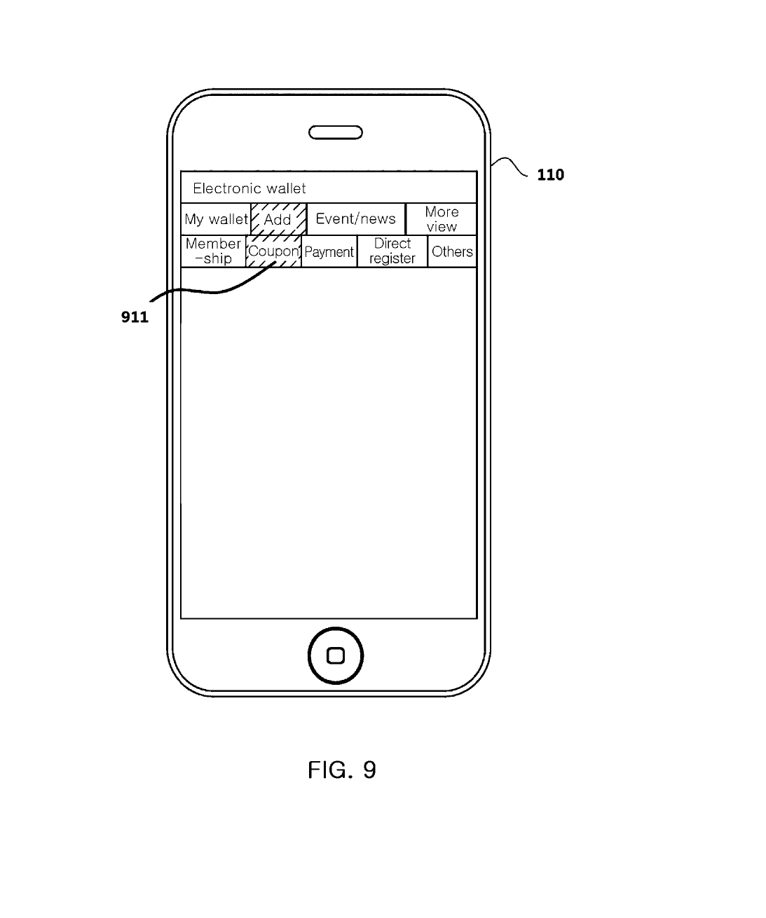

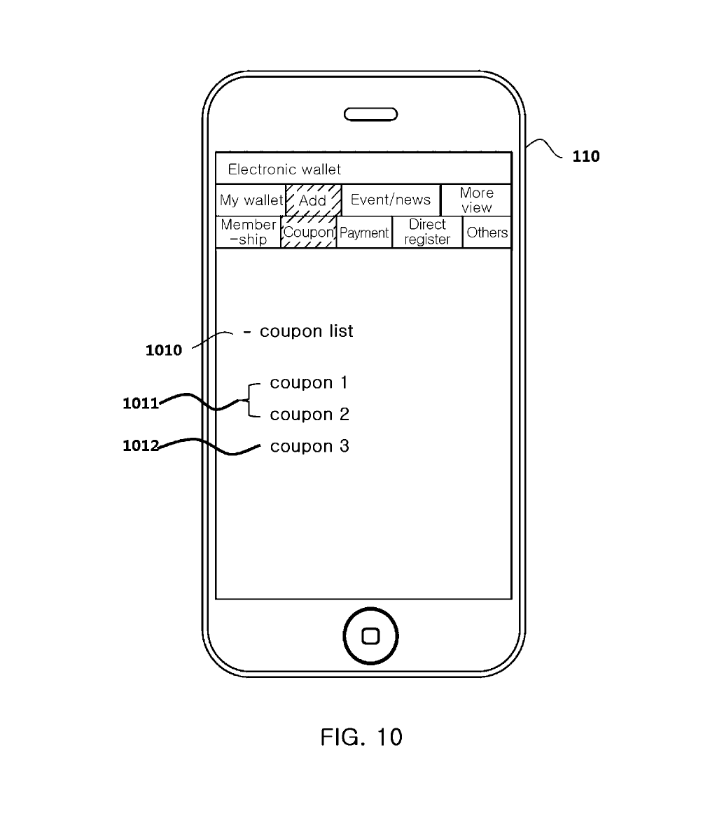

As an example, when the specific app such as the electronic wallet app pre-installed in the terminal 110 is executed, as illustrated in FIG. 8, the terminal 110 displays an electronic wallet app execution result screen 810. Here, the terminal 110 displays the execution result screen. Here, the specific app execution result screen 810 includes a my-wallet menu 811, an add menu 812, an event/news menu 813, a more-view menu 814, and the like. Thereafter, as illustrated in FIG. 9, when the coupon menu 911 included in the add menu 812 is selected in the execution result screen 810 illustrated in FIG. 8, the terminal 110 requests a coupon list to the service providing device 120 and receives the coupon list transmitted from the service providing device 120 in response to the request. Thereafter, as illustrated in FIG. 10, the terminal 110 displays a received coupon list 1010. In this case, in the coupons included in the coupon list 1010, coupon 1 and coupon 2 1011 are assigned coupons and coupon 3 1012 may be a retrieval type coupon. Further, the assigned coupon and the retrieval type coupon may be distinguished from each other by varying character colors, character sizes, character fonts, background colors, emoticons, and the like of the assigned coupon and the retrieval type coupon in the coupon list 1010 displayed on the terminal 110.

Thereafter, when the retrieval type coupon is selected from the coupon list displayed on the terminal 110, the terminal 110 transmits information on the selected retrieval type coupon to the service providing device 120. Here, the information on the retrieval type coupon includes a specific keyword included in the selected corresponding retrieval type coupon.

As an example, when a ‘Kimchi coupon’ corresponding to the coupon 3 1012 which is the retrieval type coupon is selected in the coupon list 1010 displayed on the terminal 110 illustrated in FIG. 10, the terminal 110 transmits a keyword (for example, a keyword ‘Kimchi’) for the selected ‘Kimchi coupon’ to the service providing device 120 (S720). Thereafter, the service providing device 120 receives information on the retrieval type coupon transmitted from the terminal 110.

Further, the service providing device 120 transmits the received information on the retrieval type coupon to the coupon server 130.

As an example, the service providing device 120 receives a keyword (for example. ‘Kimchi’) transmitted from the terminal 110 and transmits the received keyword (alternatively, keyword information) to the coupon server 130 (S730).

Thereafter, the coupon server 130 receives the information on the retrieval type coupon transmitted from the service providing device 120.

Further, the coupon server 130 retrieves a coupon corresponding to the received information on the retrieval type coupon among a plurality of pre-stored coupons. That is, the coupon server 130 retrieves a coupon including the received specific keyword among the plurality of pre-stored coupons.

As an example, the coupon server 130 retrieves a coupon including the received ‘Kimchi’ keyword in the corresponding affiliated company title, a coupon name, a title, and a usage place in real time among the plurality of pre-stored coupons including an affiliated company title (alternatively, an affiliated company name), a coupon name, a title, and a usage place, and the like in the latest state (S740).

Thereafter, the coupon server 130 transmits the coupon information (alternatively, the coupon) on the retrieved coupon to the corresponding terminal 110 through the service providing device 120. Here, in the retrieved coupon information, a priority displayed on the terminal 110 may be set through the coupon server 130 or the service providing device 120. Further, the retrieved coupon is an assigned coupon.

As an example, the coupon server 130 retrieves fifteen assigned coupons corresponding to the ‘Kimchi’ keyword in real time among the plurality of pre-stored coupons and transmits the retrieved fifteen assigned coupons related with the ‘Kimchi’ to the terminal 110 through the service providing device 120. Here, the retrieved fifteen assigned coupons related with the ‘Kimchi’ may include coupon 1 or coupon 2 which is the assigned coupon included in the coupon list illustrated in FIG. 8 above or not (S750).

Thereafter, the terminal 110 receives the retrieved coupon information transmitted from the service providing device 120.

Further, the terminal 110 displays the received retrieved coupon information. In this case, the displayed retrieved coupon information may be in a state where a priority for a display sequence is set by the coupon server 130 or the service providing device 120.

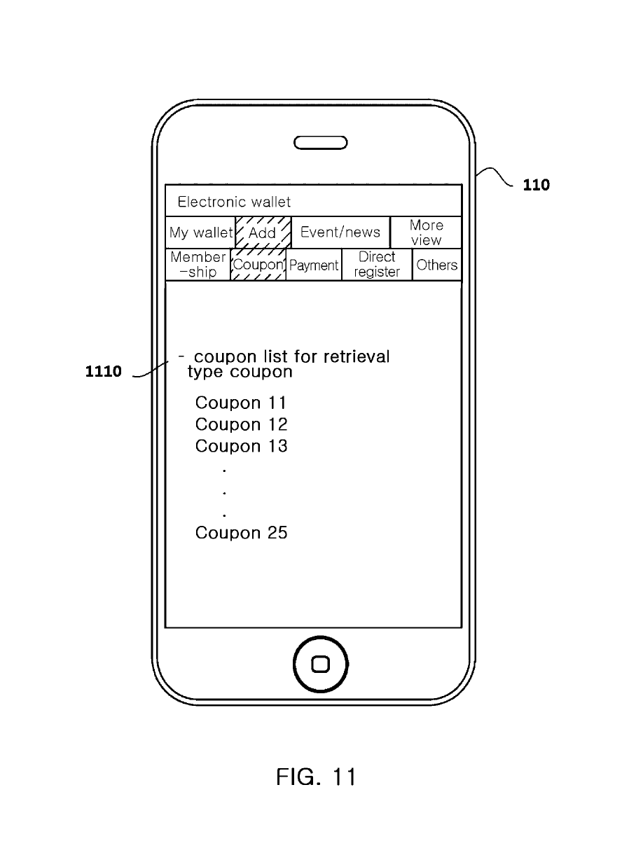

As an example, as illustrated in FIG. 11, the terminal 110 displays the received fifteen assigned coupons 1110 related with the ‘Kimchi’ (S760).

Thereafter, when any one coupon information is selected from the retrieved coupon information displayed, the terminal 110 generates a coupon issuance request signal for the coupon corresponding to the selected coupon information. Here, the coupon issuance request signal includes information on an affiliated company name, a coupon type, a coupon name, a benefit, a usage place, a usage period, a usage method, and the like, identification information on the terminal 110, and the like. In this case, the identification information on the terminal 110 includes an MDN of the terminal 110, a mobile IP, a mobile MAC, Sim card unique information, a serial number, and the like.

Further, the terminal 110 transmits the generated coupon issuance request signal to the service providing device 120.

As an example, when an eleventh coupon is selected from the fifteen assigned coupons related with the displayed Kimchi, the terminal 110 generates a coupon issuance request signal for the selected eleventh coupon and transmits the generated coupon issuance request signal to the service providing device 120 (S770).

Thereafter, the service providing device 120 receives the coupon issuance request signal transmitted from the terminal 110.

Further, the service providing device 120 transmits the coupon issuance request signal to the corresponding coupon server 130 corresponding to the information included in the received coupon issuance request signal to request the issuance of the corresponding coupon corresponding to the coupon issuance request signal.

As an example, the service providing device 120 receives the coupon issuance request signal including information on an affiliated company name, a coupon type, a coupon name, a benefit, a usage place, a usage period, a usage method, and the like, identification information on the terminal 110, and the like. Thereafter, the service providing device 120 requests the issuance of the eleventh coupon corresponding to the coupon issuance request signal to the coupon server 130 (S780).

Thereafter, the coupon server 130 receives the coupon issuance request signal transmitted from the service providing device 120.

Further, the coupon server 130 verifies a corresponding coupon corresponding to the received coupon issuance request signal among a plurality of pre-registered coupons.

As an example, the coupon server 130 verifies the eleventh coupon corresponding to the received coupon issuance request signal among the plurality of pre-registered coupons (S790).

Thereafter, the coupon server 130 issues (alternatively, transmits) the verified corresponding coupon to the terminal 110 through the service providing device 120.

Further, the coupon server 130 matches the identification information on the terminal 110 with a coupon number corresponding to the verified corresponding coupon and stores the matched coupon number corresponding to the corresponding coupon and identification information on the terminal 110.

As an example, the coupon server 130 issues the verified eleventh coupon to the terminal 110 through the service providing device 120 (S800).

Thereafter, the terminal 110 registers (alternatively, stores) the corresponding coupon issued from the service providing device 120 in response to the transmitted coupon issuance request signal.

As an example, the terminal 110 registers the eleventh coupon issued from the service providing device 120 (S810).

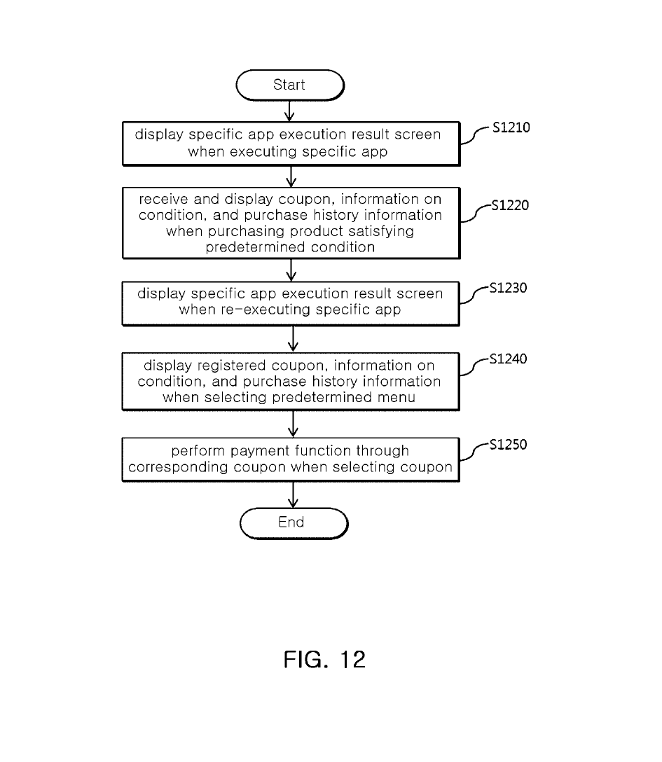

FIG. 12 is a signal flowchart illustrating a communicating process of an electronic wallet system according to a second embodiment of the present invention.

First, when a specific app such as an electronic wallet app installed in the terminal 110 is executed, the terminal 110 displays the execution result screen on the display unit 113 and communicates with the service providing device 120 via the wired or wireless communication network in a background state. In this case, the terminal 110 transmits the identification information on the terminal 110 to the service providing device 120. Here, the identification information includes an MDN, a mobile IP, a mobile MAC, Sim card unique information, a serial number, and the like of the terminal 110.

Thereafter, when purchasing a product satisfying the predetermined condition (alternatively, completing a payment for the corresponding product), the terminal 110 registers (alternatively, stores) in the specific app a coupon additionally issued (alternatively, presented) from the service providing device 120 and the coupon server 130 in response to the predetermined condition, information on the corresponding condition, and purchase history information corresponding to the corresponding product. Further, the terminal 110 displays the received coupon, the information on the corresponding condition, the purchase history information corresponding to the product, and the like on the display unit 113 through the specific app.

That is, when purchasing a product satisfying the predetermined condition, the terminal 110 performs a payment function for the corresponding product through the payment-related card (alternatively, the coupon/the gift card) pre-registered in the terminal 110 by interlocking with the POS terminal 140 provided in the store. Thereafter, when the payment function is completed, the POS terminal 140 transmits information on the corresponding product, information on the predetermined condition corresponding to the product (alternatively, condition information), payment information, store information on a store where the POS terminal 140 is positioned, identification information on the corresponding terminal 110, and the like, to the service providing device 120. Thereafter, the service providing device 120 judges (alternatively, determines) whether to issue the coupon based on the received information on the product and the received information on the condition in the pre-stored purchase history information on the plurality of products of the corresponding terminal 110. As the determined result, when the additional coupon issuance is required, the service providing device 120 requests the coupon issuance to the coupon server 130 and issues the coupon issued from the coupon server 130 in response to the coupon issuance request to the corresponding terminal 110 corresponding to the identification information on the terminal 110. In this case, the service providing device 120 transmits the pre-stored purchase history information on the corresponding product, and the information on the predetermined condition for issuing the corresponding coupon to the corresponding terminal 110 together as well as the coupon. Thereafter, the corresponding terminal 110 registers (alternatively, stores) the coupon issued from the service providing device 120, the purchase history information on the corresponding product, and the information on the predetermined condition for issuing the corresponding coupon in the specific app. Here, the coupon includes coupon information on an affiliated company title (alternatively, an affiliated company name) issuing a coupon, a coupon name, a unique code (alternatively, a coupon number), a title, a benefit, a usage place, a usage period (alternatively, an expiration date), a usage method, a coupon type (for example, a free coupon or a paid coupon), and the like. Further, the purchasing history information on the corresponding product includes information on one or more purchase dates purchasing the corresponding product, a purchase price, and the like. Further, information on a predetermined condition may be information on a purchasing condition of the corresponding product for issuing the corresponding coupon. Further, the terminal 110 displays the received coupon, the information on the corresponding condition, the purchase history information corresponding to the product, and the like on the display unit 113 through the specific app.

As an example, when completing a purchase procedure (alternatively, a payment function) for one pack of A doughnut issuing a sheet of B coffee coupon when purchasing one pack of A doughnut through the payment-related card registered in the terminal 110, the terminal 110 registers a B coffee coupon corresponding to the corresponding condition issued from the service providing device 120 and the coupon server 130, information on the corresponding condition (for example, freely issuing a sheet of B coffee coupon when purchasing one pack of A doughnut), purchase history information on the corresponding product (for example, including purchasing one pack of A doughnut on January 1, at 10:10, a purchase price of 10,000 won, and the like), and the like in the specific app (S1220).

Thereafter, when the specific app installed in the terminal 110 is re-executed, the terminal 110 displays the execution result screen on the display unit 113 and communicates with the service providing device 120 via the wired or wireless communication network in a background state.

Further, when a predetermined menu (for example, a my-wallet menu) is selected (alternatively, touched) in the execution result screen displayed on the terminal 110, the terminal 110 displays a first screen corresponding to the selected predetermined menu on the display unit 113 of the terminal 110. In this case, the first screen displayed on the display unit 113 includes a membership menu, a coupon/ticket menu, a payment menu, and the like which correspond to submenus of the predetermined menu (alternatively, a category).

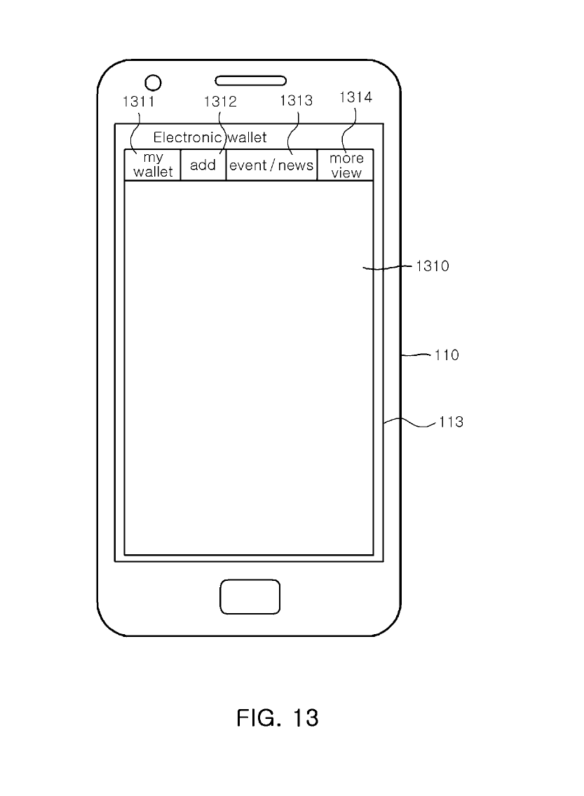

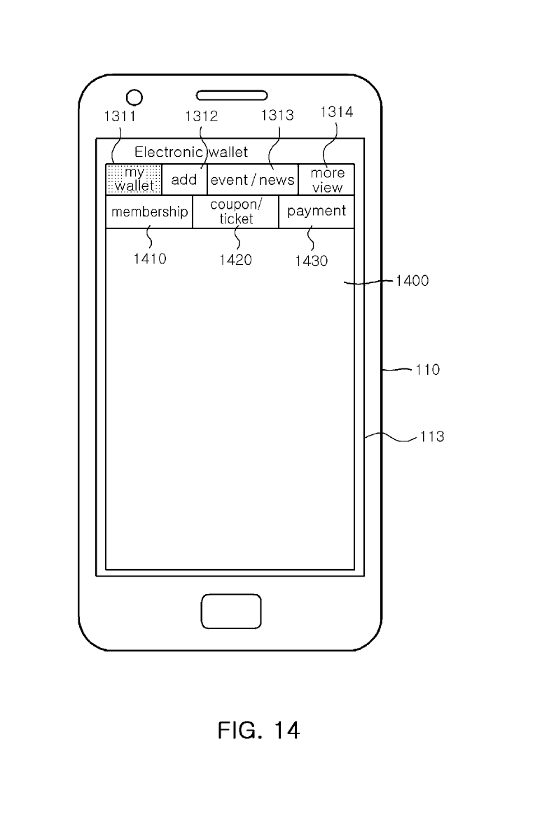

As an example, when a my-wallet menu 1311 is selected in an electronic wallet app execution result screen 1310 illustrated in FIG. 13, as illustrated in FIG. 14, the terminal 110 displays a my-wallet screen 1400 corresponding to the selected my-wallet menu 1311 on the display unit 113. Here, as illustrated in FIG. 14, the my-wallet screen 1400 includes a membership menu 1410, a coupon/ticket menu 1420, a payment menu 1430, and the like (S1230).

In the embodiment of the present invention, in order to display the first screen (for example, the my-wallet screen 1400) corresponding to the predetermined menu on the display unit 113, a predetermined menu among a plurality of menus is selected in the specific app execution result screen (for example, the electronic wallet app execution result screen 1310) and the first screen corresponding to the selected predetermined menu is displayed on the display unit 113, but the present invention is not limited thereto. In addition, when the specific app execution result screen is displayed on the display unit 113, the predetermined screen (for example, a predetermined screen corresponding to the my-wallet menu) as a default may be configured to be displayed on the display unit 113. Accordingly, in the case of the embodiment of the present invention, when the electronic wallet app is executed, as the electronic wallet app execution result displayed on the display unit 113, the may-wallet screen corresponding to the predetermined my-wallet menu may be displayed on the display unit 113 as a default. Thereafter, when the coupon/ticket menu is selected in the first screen displayed, the terminal 110 displays coupon/ticket information corresponding to one or more coupons or tickets which are pre-registered (alternatively, issued/installed) in the terminal 110 (alternatively, the specific app) on the display unit 113. Here, the coupon/ticket information includes information on an affiliated company title (alternatively, an affiliated company name), a coupon/ticket type, a coupon/ticket name, a coupon/ticket number (alternatively, a unique code), a title, a benefit, a usage place, a usage period (alternatively, an expiration date), a usage method, and the like.

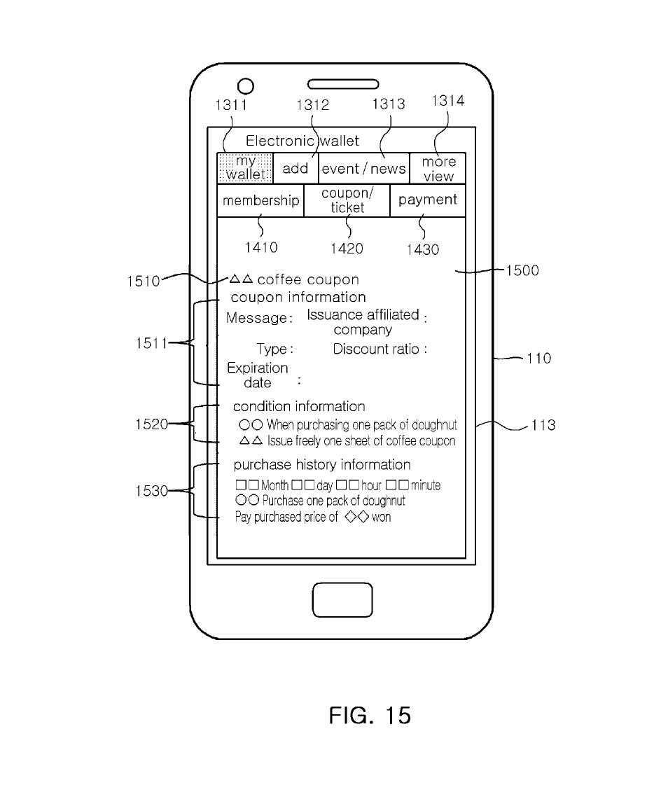

As an example, when the coupon/ticket menu 1420 is selected from the my-wallet screen 1400 illustrated in FIG. 14, as illustrated in FIG. 15, the terminal 110 displays coupon/ ticket information 1500 corresponding to one or more coupons or tickets pre-registered in the terminal 110 in response to the selected coupon/ticket menu 1420 on the display unit 113.

In this case, as illustrated in FIG. 15, coupon information 1511 on an A coffee coupon 1510 issued above, condition information 1520 for getting the corresponding A coffee coupon, and purchase history information 1530 on the product for getting the corresponding A coffee coupon are displayed together (S1240).

Thereafter, when the coupon information in which the coupon information, the condition information corresponding to the corresponding coupon information, and the purchase history information on the product for getting the corresponding coupon are displayed together is selected in the coupon/ ticket information corresponding to one or more coupons or tickets displayed on the terminal 110, the terminal 110 performs the payment function through the corresponding coupon information without a separate verification procedure for satisfying the condition by interlocking with the POS terminal 140 and the service providing device 120.

As an example, when the A coffee coupon 1510 illustrated in FIG. 15 is selected, since a state in which the corresponding A coffee coupon 1510 is a free coupon is recognized, without a separate verifying procedure for satisfying the condition, the terminal 110 performs the payment function through the A coffee coupon 1510 by interlocking with the POS terminal 140 and the service providing device 120.

Further, when the payment function is normally completed, the POS terminal 140 transmits coupon information on the paid coupon (for example, including a paid price and the like), store information on the store where the POS terminal 140 is positioned (alternatively, identification information on the POS terminal 140, unique information on the POS terminal 140, or unique identification information on the store where the POS terminal 140 is positioned), and identification information on the terminal 110, to the service providing device 120. Thereafter, the service providing device 120 receives the payment information, the store information on the store where the POS terminal 140 is positioned, and the identification information on the terminal 110, and the like, which are transmitted from the POS terminal 140.

Further, the service providing device 120 transmits the received payment information to the corresponding terminal 110 corresponding to the identification information on the terminal 110 in a push message form. Thereafter, the terminal 110 receives the push message including the payment information transmitted from the service providing device 120.

Further, the terminal 110 displays the payment information include in the received push message through the specific app (S1250).

The control method of the terminal and the coupon server according to the embodiment of the present invention may be prepared with a computer program, and codes and code segments configuring the computer program may easily deduced by a computer programmer in the art. Further, the corresponding computer program is stored in a non-transitory computer readable storage media, and read and executed by the computer or the terminal, the service providing device, the coupon server, and the like according to the embodiment of the present invention to implement the control method of the terminal and the coupon server.

The non-transitory computer readable storage media include a magnetic storage medium, an optical storage medium, and a carrier wave medium. The computer program implementing the control method of the terminal and the coupon server according to the embodiment of the present invention may be stored and installed in an embedded memory of the terminal, the service providing device, the coupon server, and the like. Alternatively, an external memory such as a smart card storing and installing the computer program implementing the control method of the terminal and the coupon server according to the embodiment of the present invention may be installed on the terminal, the service providing device, the coupon server, and the like through an interface.

In the embodiment of the present invention, as described above, in the coupon registered by the affiliated company, coupon information (alternatively, the retrieval type coupon information) related with the keyword assigned by a consumer is retrieved in real time and the retrieved coupon information is provided to the terminal to diversify the method of providing the coupon information, thereby enhancing an advertisement effect.

Further, in the embodiment of the present invention, as described above, in the coupon server, instead of performing an issuing procedure by assigning the pre-assigned coupon to the terminal one to one, the coupon information according to real-time keyword retrieval based on the terminal is provided, thereby providing coupon information based on the user.

Further, in the embodiment of the present invention, as described above, among the information on a plurality of coupons stored in the coupon server, coupon information related with the specific keyword which is desired by the user of the terminal is retrieved in real time and the coupon information related with the specific keyword retrieved in real time is provided to the terminal, thereby improving convenience of the user and reducing management costs.

Further, in the embodiment of the present invention, as described above, information on the present and history information related with the corresponding present are provided together, thereby easily verifying the purchase history information on the corresponding present.

Further, in the embodiment of the present invention, as described above, the case of purchasing the product satisfying the predetermined condition in the specific app such as an electronic wallet app, an additionally issued coupon and information on the corresponding specific condition are stored together, and the information on the specific condition may be displayed together when the information on the corresponding coupon is displayed later, thereby improving convenience of the user and enhancing availability of contents.

In the present invention, instead of performing an issuing procedure by assigning the coupon registered by the affiliated company one to one, coupon information (alternatively, retrieval type coupon information) related with the keyword assigned by the consumer among the coupons registered by the affiliated company is retrieved in real time and the retrieved coupon information is provided to the terminal to enhance an advertisement effect by diversifying the method of proving the coupon information, improve convenience of the user, and reduce management costs, and as a result, the present invention may be widely used in an electronic commerce field, a marketing field, a financial field, and the like.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description.

Therefore, the sprit of the present invention should not be limited to the above-described embodiments, and the following claims as well as all modified equally or equivalently to the claims are intended to fall within the scope and spirit of the invention.

1. A control method of a terminal, the method comprising:
displaying a coupon list received through a communication unit on a display unit when a specific app preinstalled is executed;
transmitting information on a selected retrieval type coupon including a specific keyword to the service providing device through the communication unit, when the retrieval type coupon is selected in the displayed coupon list;
receiving information on one or more coupons corresponding to the specific keyword transmitted from the service providing device in response to the information on the retrieval type coupon transmitted through the communication unit;
controlling the information on one or more coupons received through the control unit to be displayed on the display unit;
generating a coupon issuance request signal for the coupon corresponding to the selected information on the specific coupon through the control unit, when the information on the specific coupon is selected in the displayed information on one or more coupons;
transmitting the generated coupon issuance request signal to the service providing device through the communication unit; and
registering a coupon corresponding to the information on the specific coupon issued from the service providing device in response to the transmitted coupon issuance request signal through the control unit.

2. The method of claim 1, wherein the coupon list includes assigned coupons and the retrieval type coupons, the assigned coupon is a coupon registered in an affiliated company server or a coupon server, and the retrieval type coupon is a coupon for retrieving a coupon corresponding to the keyword among a plurality of pre-registered coupons including keywords.

3. The method of claim 1, wherein information on one or more coupons is in a state in which a priority for a display sequence is set.

4. A control method of a coupon server, the method comprising:
receiving information on a retrieval type coupon including a specific keyword transmitted from a service providing device through a communication unit;
retrieving a coupon corresponding to the received information on the retrieval type coupon among a plurality of coupons pre-stored in a storage unit through the control unit
transmitting coupon information on the retrieved coupon to the service providing device through the communication unit;
receiving a coupon issuance request signal including a request for issuing a specific coupon selected from the transmitted coupon information through the communication unit; and
issuing a coupon corresponding to the received coupon issuance request signal to the service providing device through the control unit.

5. The method of claim 4, wherein the the step of retrieving a coupon corresponding to the received information on the retrieval type coupon among a plurality of coupons pre-stored in a storage unit through the control unit includes retrieving a coupon including the specific keyword among an affiliated company name, a coupon name, a title, and a usage place included in the stored plurality of coupon information, respectively.

6. The method of claim 4, wherein the coupon information on the retrieved coupon is information on an assigned coupon including an affiliated company name, a coupon name, a unique code, a title, a benefit, a usage place, a usage period, a usage method, and a coupon type.

7-8. (canceled)

9. A non-transitory computer readable storage medium having a computer program comprising a set of instructions, when executed, arranged to cause a terminal to perform operations comprising:
displaying a coupon list received through a communication unit on a display unit when a specific app preinstalled is executed;
transmitting information on a selected retrieval type coupon including a specific keyword to the service providing device through the communication unit, when the retrieval type coupon is selected in the displayed coupon list;
receiving information on one or more coupons corresponding to the specific keyword transmitted from the service providing device in response to the information on the retrieval type coupon transmitted through the communication unit;
controlling the information on one or more coupons received through the control unit to be displayed on the display unit;
generating a coupon issuance request signal for the coupon corresponding to the selected information on the specific coupon through the control unit, when the information on the specific coupon is selected in the displayed information on one or more coupons;
transmitting the generated coupon issuance request signal to the service providing device through the communication unit; and
registering a coupon corresponding to the information on the specific coupon issued from the service providing device in response to the transmitted coupon issuance request signal through the control unit.

10-11. (canceled)
